(19) United States
(12) Patent Application Publication
(10) Pub. No.: US 2026/0051772 A1
(43) Pub. Date: Feb. 19, 2026

(54) WEDGE FOR ELECTROMAGNETIC MACHINE

(71) Applicant: Hamilton Sundstrand Corporation, Charlotte, NC (US)

(72) Inventors: Kris H. Campbell, Poplar Grove, IL (US); Thomas Houghton, Rockton, IL (US)

(21) Appl. No.: 18/806,313

(22) Filed: Aug. 15, 2024

(51) Int. Cl. H02K 1/22; H02K 3/04

(52) U.S. Cl. CPC H02K 1/22; H02K 3/04

(57) ABSTRACT

A method includes wrapping a magnet wire around a first side and a second side of each of a plurality of posts of a rotor body to form a plurality of coils on each of the plurality of posts. The method also includes inserting a first wedge liner into a slot landing between adjacent posts of the plurality of posts and inserting a second wedge liner into the slot landing between adjacent posts of the plurality of posts. The method further includes coupling the first wedge liner and the second wedge liner to form a wedge liner opening and inserting a wedge piece into the wedge liner opening.

### TECHNICAL FIELD

This disclosure relates generally to systems and methods for manufacturing electromagnetic machines. More specifically, this disclosure relates to the use of wedges for an electromagnetic machine that is easy to assemble.

### BACKGROUND

Electricity generation often depends on electromagnetic induction where a current is induced in a wire coil when a magnetic field acts on upon the coil, such as by a magnet near the wire coil, and induces an electromotive force on the coil. In a rotor, the rotor spins within a stationary cylinder or stator. As the rotor turns, an electrical current will flow through each section of the wire coil, turning each section into a separate conductor. The currents from individual sections merge to form a single larger current.

### SUMMARY

This disclosure relates to the use of wedges for an electromagnetic machine that is easy to assemble.

In some examples, a rotor assembly may include a rotor body comprising a plurality of posts, a plurality of coils disposed on a first side and a second side of each of the plurality of posts, and a wedge assembly comprising a first wedge liner and a second wedge liner disposed between coils of adjacent posts of the plurality of posts.

Any single one or any combination of the following features may be used with the examples above. The second wedge liner may be hingedly coupled to the first wedge liner. The first wedge liner may include an array of first alignment slots coupled to an array of second alignment slots of the second wedge liner. The first wedge liner and the second wedge liner may be coupled to form a wedge liner opening. The wedge assembly may include a wedge piece disposed in the wedge liner opening. The wedge piece may be coupled to the first wedge liner and the second wedge liner. The first wedge liner may include a first wing outer protrusion and a first wing inner protrusion. The second wedge liner may include a second wing outer protrusion and a second wing inner protrusion. The wedge piece may be coupled to the first wing inner protrusion and the second wing inner protrusion.

In other examples, a wedge assembly may include a first wedge liner, a second wedge liner coupled to the first wedge liner, and a wedge piece coupled to the first wedge liner and the second wedge liner.

Any single one or any combination of the following features may be used with the examples above. The first wedge liner and the second wedge liner may be coupled to form a wedge liner opening. The first wedge liner may include an array of first alignment slots and an array of first alignment protrusions hingedly coupled to an array of second alignment slots and an array of second alignment protrusions of the second wedge liner. The array of first alignment protrusions may couple to the array of second alignment slots. The array of second alignment protrusions may couples to the array of first alignment slots. The array of first alignment slots may be disposed along a first body inner edge of the first wedge liner. A first wing may be disposed along a first body outer edge opposite the first body inner edge. The array of second alignment slots may be disposed along a second body inner edge of the second wedge liner. A second wing may be disposed along a second body outer edge opposite the second body inner edge. The first wing may include a first wing outer protrusion and a first wing inner protrusion. The second wing may include a second wing outer protrusion and a second wing inner protrusion. The wedge piece may be coupled to the first wing inner protrusion and the second wing inner protrusion.

In still other examples, a method may include wrapping a magnet wire around a first side and a second side of each of a plurality of posts of a rotor body to form a plurality of coils on each of the plurality of posts. The method may also include inserting a first wedge liner into a slot landing between adjacent posts of the plurality of posts and inserting a second wedge liner into the slot landing between adjacent posts of the plurality of posts. The method may further include coupling the first wedge liner and the second wedge liner to form a wedge liner opening and inserting a wedge piece into the wedge liner opening.

Any single one or any combination of the following features may be used with the examples above. Inserting the first wedge liner may include inserting the first wedge liner along a radial axis perpendicular to a center axis of the rotor body into the slot landing. Inserting the second wedge liner may include inserting the second wedge liner along a radial axis perpendicular to a center axis of the rotor body into the slot landing. Coupling the first wedge liner and the second wedge liner may include inserting an array of first alignment protrusions of the first wedge liner into an array of second alignment slots of the second wedge liner to hingedly couple the second wedge liner to the first wedge liner. Inserting the wedge piece may include inserting the wedge piece longitudinally along a longitudinal axis parallel to a center axis of the rotor body into the wedge liner opening. After inserting the wedge piece into the wedge liner opening, the wedge piece may couple to a first wing of the first wedge liner and a second wing of the second wedge liner.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an exploded view of an example rotor assembly in accordance with this disclosure;

FIG. 2A illustrates a perspective top view of an example wedge assembly of a rotor assembly in accordance with this disclosure;

FIG. 2B illustrates a perspective bottom view of the wedge assembly of FIG. 2A in accordance with this disclosure; and

FIG. 3 illustrates an example method of assembling a rotor assembly in accordance with this disclosure.

### DETAILED DESCRIPTION

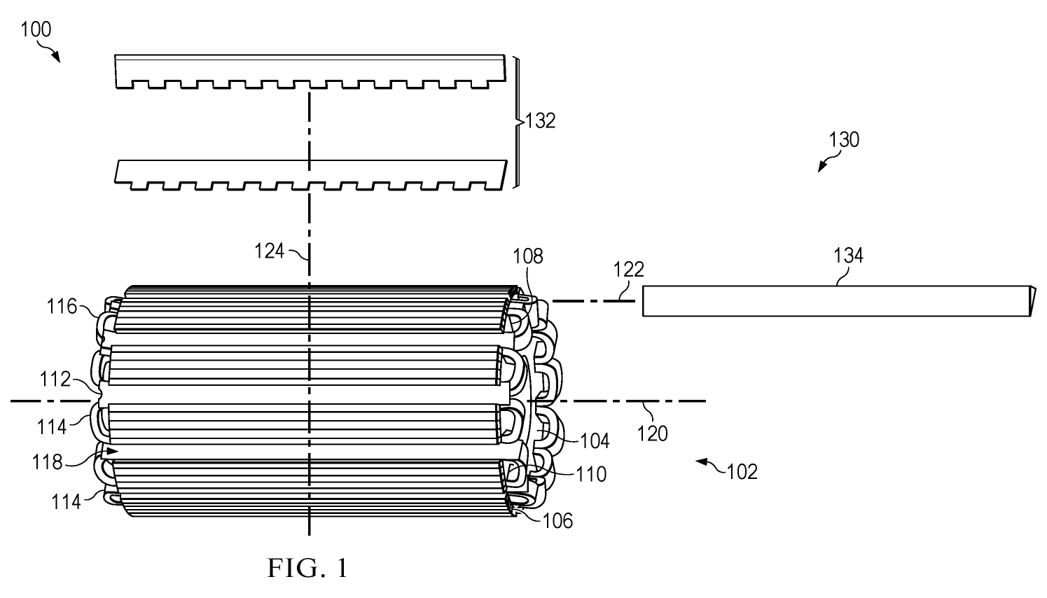

FIGS. 1 through 3, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, electricity generation often depends on electromagnetic induction where a current is induced in a wire coil when a magnetic field acts on upon the coil, such as by a magnet near the wire coil, and induces an electromotive force on the coil. In a rotor, the rotor spins within a stationary cylinder or stator. As the rotor turns, an electrical current will flow through each section of the wire coil, turning each section into a separate conductor. The currents from individual sections merge to form a single larger current.

A rotor is a dynamic component of an electromagnetic system and can be integral to devices such as electric motors, generators, and alternators. The rotor can rotate due to the interaction between windings and magnetic fields, generating a torque around its axis. A rotor may include primarily rotor coils, a rotor shaft, and wedges storied in slots along the axial direction of the shaft. Once the coils are fitted into the slots, wedges can be placed in the slot landing. The wedging process aims to restrain the coils in the slot against steady-state bar forces and transient bar forces. This ensures the stability of the rotor during operation and prevents coil movement due to operational forces. High power density machines rotate at high speeds and generate large centrifugal forces and large amounts of heat, and a centrifugal force exerted by the coils is held back by the wedges.

Insulative layers can be used between the wedges and the rotor coils to prevent electrical contact between the rotor coils and the wedges, thus reducing short circuits and other operational issues. Insulative layers can also shield the rotor coils from mechanical wear and damage. Unfortunately, during installation of the wedges in the rotor, the wedges are inserted between the rotor coils and may damage the insulative layers, which can affect both stand-alone insulative layers and insulative layers that are coated on magnet wires. Because high power density machines rotate at high speeds and generate large centrifugal forces and large amounts of heat, these qualities result in the need for a strong and thermally conductive wedge material. As needs increase, design trade-offs may result in multiple-material parts or parts with cooling channels built in. Moreover, as complexity grows, the fits become tighter.

This disclosure provides for the use of wedges for an electromagnetic machine that is easy to assemble. For example, embodiments of this disclosure can include use of a two-piece wedge liner and a wedge body. During installation, the disclosed wedge assembly can push fragile components in compression rather than as a shear force. For instance, the liner can be installed in a slot first and spread out to contact magnet wires, and a wedge can be installed axially without directly contacting the magnet wires. As a result, these techniques can reduce or avoid damage to insulative layers or other components in rotor assemblies.

FIG. 1 illustrates an exploded view of an example rotor assembly 100 in accordance with this disclosure. As shown in FIG. 1, the rotor assembly 100 can include a rotor body 102 having a electromagnetic core 104 and a plurality of posts 106. Each post 106 can include an first side 108, an second side 110, and a gap 112 between the first side 108 and the second side 110. Each post 106 may be radially disposed about a center axis 120 of the rotor body 102, such as when the post 106 extends from a radial axis 124 perpendicular to the center axis 120. The rotor assembly 100 can also include coils 114 formed using a magnet wire 116 wrapped around the gap 112 of each post 106. Between each post 106 is a slot landing 118, meaning there can be a slot landing 118 between coils 114 of adjacent posts 106. A wedge assembly 130 having a two-piece wedge liner 132 and a wedge piece 134 can be disposed in each slot landing 118 between each of the posts 106. While one wedge assembly 130 is shown here, the rotor assembly 100 can include multiple wedge assemblies 130. During operation, the rotor body 102 rotates, and the posts 106 move relative to the electromagnetic core 104 to generate an electrical current flowing within the coils 114.

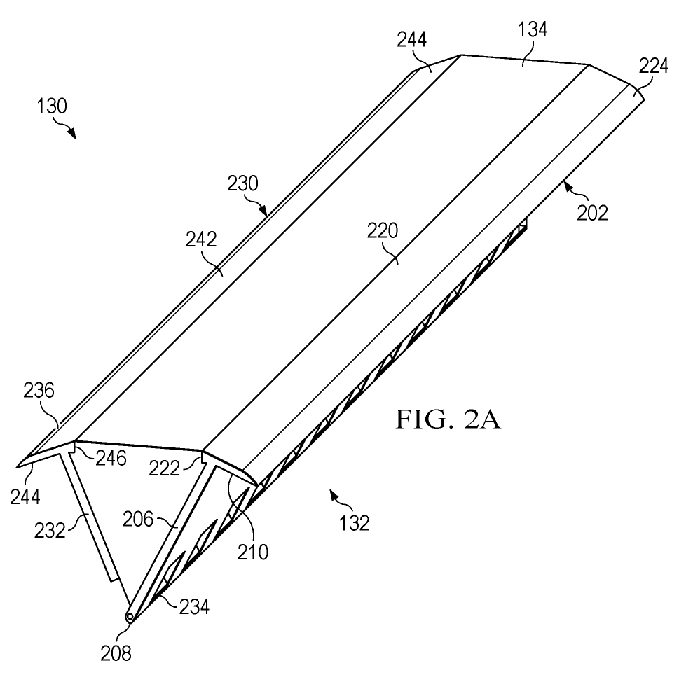

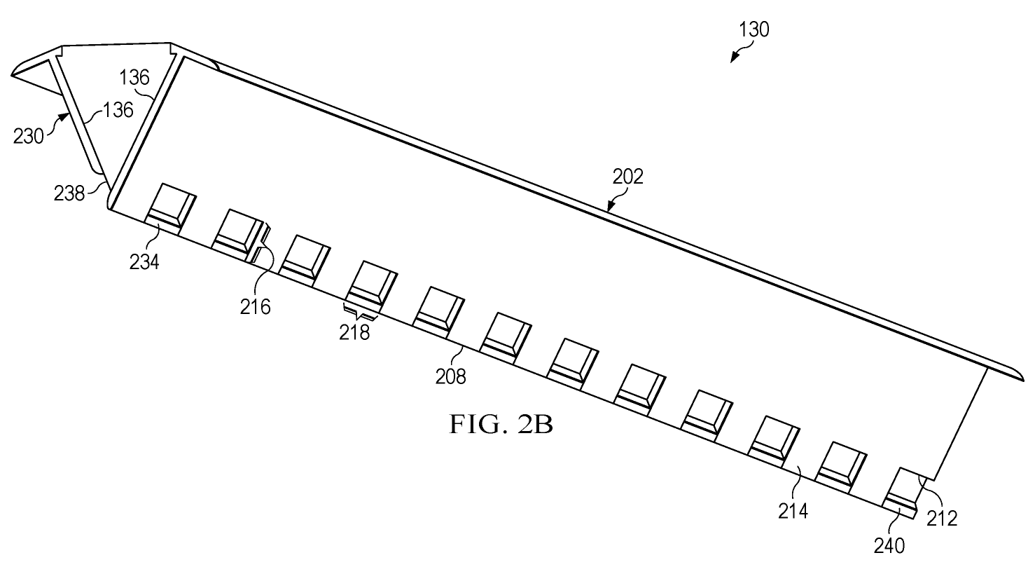

FIG. 2A illustrates a perspective top view of an example wedge assembly 130 of a rotor assembly 100 in accordance with this disclosure, and FIG. 2B illustrates a perspective bottom view of the wedge assembly 130 of FIG. 2A in accordance with this disclosure. As shown in FIGS. 2A and 2B, the two-piece wedge liner 132 can include a first wedge liner 202 and a second wedge liner 230. The first wedge liner 202 can include a first body 206 having a first body inner edge 208 and a first body outer edge 210 opposite the first body inner edge 208. The first wedge liner 202 can also include an array of first alignment slots 212 and an array of first alignment protrusions 214 along the first body inner edge 208 of the first body 206. In some cases, the first alignment slots 212 and the first alignment protrusions 214 can alternate to form a keyed profile. Each of the first alignment slots 212 includes a slot height 216 and a slot width 218. The first wedge liner 202 can further include a first wing 220 disposed along the first body outer edge 210 of the first body 206. The first wing 220 can include a first wing inner protrusion 222 opposite of a first wing outer protrusion 224. The first wing inner protrusion 222 can be configured to couple to the wedge piece 134 and secure the wedge piece 134 to the first wedge liner 202.

Similarly, the second wedge liner 230 can include a second body 232 having a second body inner edge 234 and a second body outer edge 236 opposite the second body inner edge 234. The second wedge liner 230 can also include an array of second alignment slots 238 and an array of second alignment protrusions 240 along the second body inner edge 234 of the second wedge liner 230. The second alignment slots 238 and the second alignment protrusions 240 could alternate similarly to the first alignment slots 212 and the first alignment protrusions 214. The second wedge liner 230 may further include a second wing 242 disposed along the second body outer edge 236 of the second wedge liner 230. The second wing 242 can include a second wing inner protrusion 244 and a second wing outer protrusion 246. The second wing inner protrusion 244 can be configured to couple to the wedge piece 134 and secure the wedge piece 134 to the second wedge liner 230.

The first wedge liner 202 and the second wedge liner 230 may be configured to hingedly couple along the first body inner edge 208 and the second body inner edge 234 using the array of first alignment slots 212, the array of first alignment protrusions 214, the array of second alignment slots 238, and the array of second alignment protrusions 240. When coupled, the array of first alignment protrusions 214 of the first wedge liner 202 can couple to and be at least partially disposed in the array of second alignment slots 238 of the second wedge liner 230. Similarly, the array of second alignment protrusions 240 of the second wedge liner 230 can couple to and may be at least partially disposed in the array of first alignment slots 212 of the first wedge liner 202. When the first wedge liner 202 and the second wedge liner 230 couple, the two-piece wedge liner 132 can be assembled and form a thermally conductive barrier between the wedge piece 134 and the coils 114 in the slot landing 118.

The first wing outer protrusion 224 of the first wedge liner 202 and the second wing outer protrusion 246 of the second wedge liner 230 can couple to and contact the first side 108 of the nearest of the plurality of posts 106 to secure the wedge assembly 130 relative to the rotor assembly 100. Additionally, the wedge piece 134 may include cooling channels (not shown) that are configured to remove thermal energy from the wedge assembly 130 during operation of the rotor assembly 100.

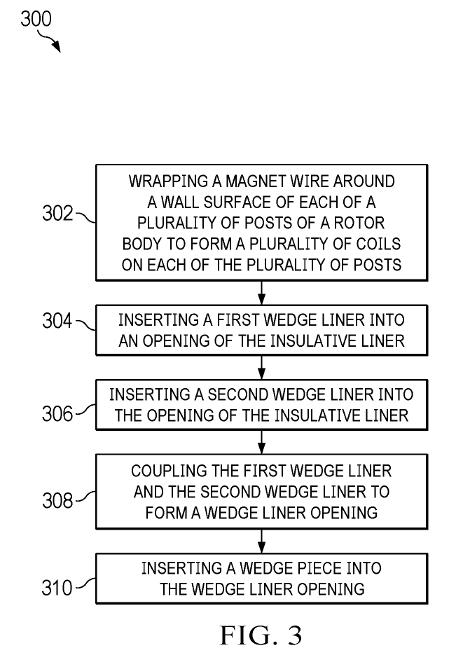

FIG. 3 illustrates an example method 300 of assembling a rotor assembly in accordance with this disclosure. For example, the method 300 may be used to assemble the rotor assembly 100 using the wedge assembly 130. As shown in FIG. 3, in operation 302, a magnet wire 116 is wrapped around the first side 108 and the second side 110 of each of a plurality of posts 106 of a rotor body 102 to form a plurality of coils 114 on each of the posts 106. In operation 304, a first wedge liner 202 is inserted into a slot landing 118. Inserting the first wedge liner 202 may include inserting the first wedge liner 202 along a radial axis 124 perpendicular to a center axis 120 of the rotor body 102 into the slot landing 118. In operation 306, a second wedge liner 230 is inserted into the slot landing 118. Inserting the second wedge liner 230 may include inserting the second wedge liner 230 along a radial axis 124 perpendicular to a center axis 120 of the rotor body 102 into the slot landing 118.

In operation 308, the first wedge liner 202 and the second wedge liner 230 are coupled to form a wedge liner landing 136. This could include inserting an array of first alignment protrusions 214 of the first wedge liner 202 into an array of second alignment slots 238 of the second wedge liner 230 to hingedly couple the second wedge liner 230 to the first wedge liner 202. Similarly, an array of second alignment protrusions 240 of the second wedge liner 230 may be inserted into an array of first alignment slots 212 of the first wedge liner 202. Once the first wedge liner 202 and the second wedge liner 230 are hingedly coupled, the first wedge liner 202 and the second wedge liner 230 may be opened such that the outer edges of the wedge liners are separated from each other, creating a wedge liner landing 136.

In operation 310, a wedge piece 134 is inserted into the wedge liner landing 136. This could include inserting the wedge piece 134 longitudinally along a longitudinal axis 122 parallel to a center axis 120 of the rotor body 102 into the wedge liner landing 136. As the wedge piece 134 is inserted, the wedge piece 134 can contact the surface of the wedge liner landing 136 but not a surface of the coils 114 or posts 106 of the rotor assembly 100. This allows for any frictional or shear force created by inserting the wedge piece 134 from affecting the positioning of the coils 114 or damaging any insulative layers disposed in the slot landing 118. Once the wedge piece 134 is coupled to the first wedge liner 202 and the second wedge liner 230, the wedge piece may be secured, e.g., with a plug, on one or both ends.

Among other things, this disclosure allows for assembly of fragile components of a rotor assembly to be in compression rather than as a shear force by using wedge pieces and wedge liners. The wedge liners can be installed in a slot landing and spread out to contact magnet wires or coils. The wedge pieces can be installed axially without generating shear forces on the magnet wires. Without the shear forces, the likelihood of damage to the rotor assembly can be significantly reduced or eliminated.

It may be advantageous to set forth definitions of certain words and phrases used throughout this patent document. The terms “include” and “comprise” as well as derivatives thereof, mean inclusion without limitation. The term “or” is inclusive, meaning and/or. The phrase “associated with” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A rotor assembly comprising:
a rotor body comprising a plurality of posts;
a plurality of coils disposed on a first side and a second side of each of the plurality of posts; and
a wedge assembly comprising a first wedge liner and a second wedge liner disposed between coils of adjacent posts of the plurality of posts.

2. The rotor assembly of claim 1, wherein the second wedge liner is hingedly coupled to the first wedge liner.

3. The rotor assembly of claim 1, wherein the first wedge liner comprises an array of first alignment slots coupled to an array of second alignment slots of the second wedge liner.

4. The rotor assembly of claim 1, wherein the first wedge liner and the second wedge liner are coupled to form a wedge liner opening.

5. The rotor assembly of claim 4, wherein the wedge assembly further comprises a wedge piece disposed in the wedge liner opening.

6. The rotor assembly of claim 5, wherein the wedge piece is coupled to the first wedge liner and the second wedge liner.

7. The rotor assembly of claim 5, wherein:
the first wedge liner comprises a first wing outer protrusion and a first wing inner protrusion;
the second wedge liner comprises a second wing outer protrusion and a second wing inner protrusion; and
the wedge piece is coupled to the first wing inner protrusion and the second wing inner protrusion.

8. A wedge assembly comprising:
a first wedge liner;
a second wedge liner coupled to the first wedge liner; and
a wedge piece coupled to the first wedge liner and the second wedge liner.

9. The wedge assembly of claim 8, wherein the first wedge liner and the second wedge liner are coupled to form a wedge liner opening.

10. The wedge assembly of claim 8, wherein the first wedge liner comprises an array of first alignment slots and an array of first alignment protrusions hingedly coupled to an array of second alignment slots and an array of second alignment protrusions of the second wedge liner.

11. The wedge assembly of claim 10, wherein:
the array of first alignment protrusions couples to the array of second alignment slots; and
the array of second alignment protrusions couples to the array of first alignment slots.

12. The wedge assembly of claim 10, wherein:
the array of first alignment slots is disposed along a first body inner edge of the first wedge liner;
a first wing is disposed along a first body outer edge opposite the first body inner edge;
the array of second alignment slots is disposed along a second body inner edge of the second wedge liner; and
a second wing is disposed along a second body outer edge opposite the second body inner edge.

13. The wedge assembly of claim 12, wherein:
the first wing comprises a first wing outer protrusion and a first wing inner protrusion; and
the second wing comprises a second wing outer protrusion and a second wing inner protrusion.

14. The wedge assembly of claim 13, wherein the wedge piece is coupled to the first wing inner protrusion and the second wing inner protrusion.

15. A method comprising:
wrapping a magnet wire around a first side and a second side of each of a plurality of posts of a rotor body to form a plurality of coils on each of the plurality of posts;
inserting a first wedge liner into a gap between adjacent coils of the plurality of coils;
inserting a second wedge liner into the gap between adjacent coils of the plurality of coils;
coupling the first wedge liner and the second wedge liner to form a wedge liner opening; and
inserting a wedge piece into the wedge liner opening.

16. The method of claim 15, wherein inserting the first wedge liner comprises inserting the first wedge liner along a radial axis perpendicular to a center axis of the rotor body into the slot landing.

17. The method of claim 15, wherein inserting the second wedge liner comprises inserting the second wedge liner along a radial axis perpendicular to a center axis of the rotor body into the slot landing.

18. The method of claim 15, wherein coupling the first wedge liner and the second wedge liner comprises inserting an array of first alignment protrusions of the first wedge liner into an array of second alignment slots of the second wedge liner to hingedly couple the second wedge liner to the first wedge liner.

19. The method of claim 15, wherein inserting the wedge piece comprises inserting the wedge piece longitudinally along a longitudinal axis parallel to a center axis of the rotor body into the wedge liner opening.

20. The method of claim 15, wherein, after inserting the wedge piece into the wedge liner opening, the wedge piece couples to a first wing of the first wedge liner and a second wing of the second wedge liner and wherein the wedge piece is secured with a plug.
